(19) United States
(12) Patent Application Publication
(10) Pub. No.: US 2024/0178653 A1
(43) Pub. Date: May 30, 2024

(54) GROUND FAULT DETECTION IN AC SYSTEMS USING DIGITAL SIGNAL PROCESSING

(71) Applicant: Amber Semiconductor, Inc., Dublin, CA (US)

(72) Inventors: Mark Telefus, Orinda, CA (US); Harry Rodriguez, San Jose, CA (US); Suhail Zain, San Ramon, CA (US)

(21) Appl. No.: 18/523,333

(22) Filed: Nov. 29, 2023

Related U.S. Application Data
(60) Provisional application No. 63/428,465, filed on Nov. 29, 2022.

(51) Int. Cl. H02H 3/32; H02H 1/00

(52) U.S. Cl. CPC H02H 3/32; H02H 1/0007

(57) ABSTRACT

A device comprises current sense circuitry, analog-to-digital converter circuitry, and digital signal processing circuitry. The current sense circuitry is configured to sense a first current flowing in a first wire and a second current flowing in a second wire, the first and second wires being configured to supply AC power to a load coupled to the device. The analog-to-digital converter circuitry is configured to generate first digital data corresponding to the first current, and second digital data corresponding to the second current. The digital signal processing circuitry is configured to process the first digital data and the second digital data to determine a difference between the first current and the second current, and to generate a control signal to interrupt current flow in the first and second wires, in response to determining that the difference between the first current and the second current meets or exceeds a difference threshold.

### CROSS-REFERENCE TO RELATED APPLICATION

This application claims priority to U.S. Provisional Application Ser. No. 63/428,465, filed on Nov. 29, 2022, the disclosure of which is fully incorporated herein by reference.

### TECHNICAL FIELD

This disclosure relates to devices and methods for monitoring and detecting ground faults, and protecting against ground fault conditions.

### BACKGROUND

A ground fault is an unintentional electrical path between a power source (e.g., hot line or neural line of AC system) and earth ground or chassis ground. A ground fault circuit interrupter (GFCI) device (e.g., GFCI circuit breaker, GFCI outlet, etc.) is a device that is configured to monitor current on a hot line (hot line current) and return current on a neutral line (neutral line current) to determine if there is a difference (differential current) between hot and neutral line currents. In the event that a differential current is detected within a certain threshold (e.g., 5 milliamps), the GFCI device will interrupt power delivered to a device or load connected to the GFCI device. The occurrence of the differential current means some leakage current is flowing through some undesired path to ground. The GFCI device will cut-off the power to protect against the ground fault. Typically, a GFCI device is designed to quickly interrupt power (e.g., at a speed between 25-40 milliseconds) after detecting a ground fault.

Conventional GFCI devices implement current sensing transformers (e.g., toroidal sensors) which are configured to compare the amount of hot line current and the amount of neutral line current flowing to and from a load connected to the GFCI device. There are various drawbacks to conventional GFCI devices. For example, the current sensing toroidal components that are typically utilized to monitor the hot and neutral currents are bulky components which occupy a relatively large amount of space within a housing of the GFCI device. In addition, conventional GFCI devices are prone to nuisance tripping. For example, a GFCI device can trip as a result of the accumulated leakage current of multiple devices connected to the load side of the GFCI device, or when a given electrical appliance is leaking too much current to ground for a particular reason. In addition, nuisance tripping of a GFCI device can occur in areas with a relatively high level of moisture or condensation. Other causes of nuisance tripping include, but are not limited to, a defective GFCI device, improper wiring of the GFCI device, faulty wiring, etc. In such instances, the only thing a person can do is reset the GFCI device (e.g., pressing a reset button on a GFCI outlet), and hope the fault goes away. The GFCI device provides no indication as to why the tripping occurred.

### SUMMARY

Exemplary embodiments of the disclosure include devices and methods for detecting and protecting against ground fault conditions.

An exemplary embodiment includes a device which comprises current sense circuitry, analog-to-digital converter circuitry, and digital signal processing circuitry. The current sense circuitry is configured to sense a first current flowing in a first wire and to sense a second current flowing in a second wire, the first and second wires being configured to supply AC power to a load coupled to the device. The analog-to-digital converter circuitry is configured to generate first digital data corresponding to the first current, and to generate second digital data corresponding to the second current. The digital signal processing circuitry is configured to (i) process the first digital data and the second digital data to determine a difference between the first current and the second current, and (ii) generate a control signal to interrupt current flow in the first and second wires, in response to determining that the difference between the first current and the second current meets or exceeds a difference threshold.

Another exemplary embodiment includes a device which comprises: a first electrical path and a second electrical path configured to supply alternative current (AC) power to a load coupled to the device; a first current sense resistor configured to generate a first sense voltage corresponding to a first current flowing in the first electrical path; a second current sense resistor configured to generate a second sense voltage corresponding to a second current flowing in the second electrical path; a first analog-to-digital converter circuit configured to convert the first sense voltage to a first digital voltage; a second analog-to-digital converter circuit configured to convert the second sense voltage to a second digital voltage; and control circuitry configured to (i) process the first digital voltage and the second digital voltage to determine a difference between the first current and the second current, and (ii) generate a control signal to interrupt current flow in the first and second electrical paths, in response to determining that the difference between the first current and the second current meets or exceeds a difference threshold.

In another exemplary embodiment, which may be combined with one or more of the embodiments of the preceding paragraphs, the device comprises a ground fault circuit interrupter outlet device.

In another exemplary embodiment, which may be combined with one or more of the embodiments of the preceding paragraphs, the device comprises a ground fault circuit interrupter circuit breaker device.

Another exemplary embodiment includes a method which comprises: sensing a first current flowing in a first wire and a second current flowing in a second wire, the first and second wires being configured to supply alternative current (AC) power to a load; generating first digital data corresponding to the first current, and second digital data corresponding to the second current; and processing the first digital data and the second digital data to determine a difference between the first current and the second current, and generate a control signal to interrupt current flow in the first and second wires, in response to determining that the difference between the first current and the second current meets or exceeds a difference threshold.

Other embodiments will be described in the following detailed description of exemplary embodiments, which is to be read in conjunction with the accompanying figures.

### BRIEF DESCRIPTION OF THE DRAWINGS

FIG. 1 schematically illustrates a device for detecting and protecting against ground fault conditions, according to an exemplary embodiment of the disclosure.

FIG. 2 illustrates a flow diagram of a method for detecting and protecting against ground fault conditions, according to an exemplary embodiment of the disclosure.

FIG. 3 schematically illustrates a system for detecting and protecting against ground fault conditions, according to an exemplary embodiment of the disclosure.

### DETAILED DESCRIPTION

Embodiments of the disclosure will now be described in further detail with regard to devices and methods for detecting ground fault conditions, and protecting against ground fault conditions. It is to be understood that the various features shown in the accompanying drawings are schematic illustrations that are not drawn to scale. Moreover, the same or similar reference numbers are used throughout the drawings to denote the same or similar features, elements, or structures, and thus, a detailed explanation of the same or similar features, elements, or structures will not be repeated for each of the drawings. Further, the term “exemplary” as used herein means “serving as an example, instance, or illustration.” Any embodiment or design described herein as “exemplary” is not to be construed as preferred or advantageous over other embodiments or designs.

Further, it is to be understood that the phrase “configured to” as used in conjunction with a circuit, structure, element, component, or the like, performing one or more functions or otherwise providing some functionality, is intended to encompass embodiments wherein the circuit, structure, element, component, or the like, is implemented in hardware, software, and/or combinations thereof, and in implementations that comprise hardware, wherein the hardware may comprise discrete circuit elements (e.g., transistors, inverters, etc.), programmable elements (e.g., application specific integrated circuit (ASIC) devices, field programmable gate array (FPGA) devices, etc.), processing devices (e.g., central processing unit (CPU) devices, graphical processing unit (GPU) devices, microcontroller devices, etc.), one or more integrated circuits, and/or combinations thereof. Thus, by way of example only, when a circuit, structure, element, component, etc., is defined to be configured to provide a specific functionality, it is intended to cover, but not be limited to, embodiments where the circuit, structure, element, component, etc., is comprised of elements, processing devices, and/or integrated circuits that enable it to perform the specific functionality when in an operational state (e.g., connected or otherwise deployed in a system, powered on, receiving an input, and/or producing an output), as well as cover embodiments when the circuit, structure, element, component, etc., is in a non-operational state (e.g., not connected nor otherwise deployed in a system, not powered on, not receiving an input, and/or not producing an output) or in a partial operational state.

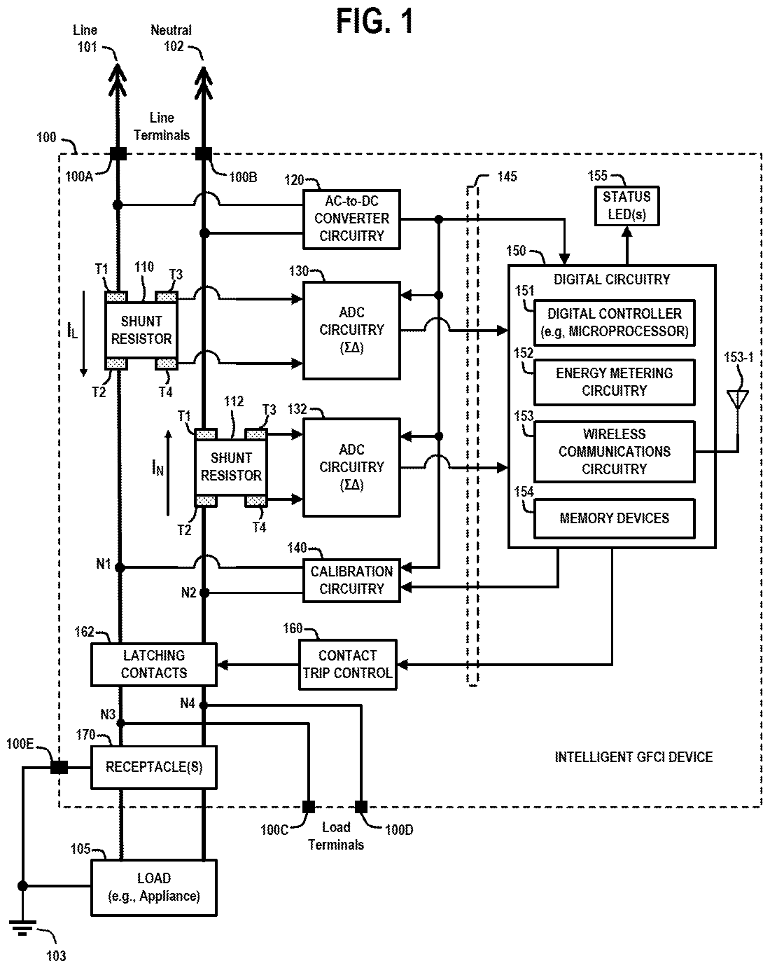

FIG. 1 schematically illustrates a device for detecting and protecting against ground fault conditions, according to an exemplary embodiment of the disclosure. In particular, FIG. 1 schematically illustrates a GFCI device 100 (e.g., GFCI outlet) which comprises first and second power input terminals 100A and 100B, first and second load terminals 100C and 100D, and a ground terminal 100E. The first and second power input terminals 100A and 100B are utilized to connect the GFCI device 100 to a hot line 101 (ungrounded power supply line (or Line)) and a neutral line 102 (grounded power supply line (or Neutral). The first and second load terminals 100C and 100D are utilized to connect the GFCI device 100 to one or more downstream devices (e.g., electrical outlets) that are connected on a same branch circuit, and allow the GFCI device 100 to provide GFCI protection to the one or more downstream devices on the same branch circuit.

The ground terminal 100E is utilized to connect the GFCI device 100 to earth ground 103 (or equipment ground 103). The hot line 101 and the neutral line 102 supply AC power (e.g., 120 V RMS, 60 Hz) to a load 105 (e.g., appliance) that is connected to the GFCI device 100 (e.g., electrical device or appliance plugged into a receptable 170 of the GFCI device 100).

As further schematically shown in FIG. 1, the GFCI device 100 comprises a first shunt resistor 110 (more generally, a first current sensor device), a second shunt resistor 112 (more generally, second current sensor device), a power converter circuit 120 (e.g., AC-to-DC converter circuitry 120), a first analog-to-digital (ADC) circuit 130, a second ADC circuit 132, a calibration circuit 140, isolation circuitry 145, digital circuitry 150, one or more status light-emitting diodes (LEDs) 155, a contact trip control element 160, latching contacts 162, and one or more receptacles 170 (or outlets). The latching contacts 162 are configured to connect/disconnect nodes N1 and N2 to/from nodes N3 and N4, respectively. The nodes N3 and N4 comprise first and second load output nodes. The isolation circuitry 145 is configured to isolate the digital and analog power domains of the analog and digital circuitry of the GFCI device 100. Although the isolation circuitry 145 is generically illustrated in FIG. 1, it is to be understood that the isolation circuitry 145 can be implemented using any suitable isolation circuitry and isolation techniques. For example, in some embodiments, the isolation circuitry 145 can be implemented using photovoltaic isolation circuits and techniques to provide the required isolation between the digital and analog power domains.

The digital circuitry 150 comprises various circuit components that are configured to control various functions and operations of the GFCI device 100 such as sensing operations, data processing and management operations, wired/wireless communications, and other intelligent functions, etc. In some embodiments, the digital circuitry 150 comprises a digital controller 151, energy metering/monitoring circuitry 152, wireless communications circuitry 153 and an associated antenna 153-1, and memory devices 154. The digital controller 151 is configured to implement GFCI control functions as described herein. In some embodiments, the digital controller 151 comprises a microprocessor, a microcontroller, an application-specific integrated circuit (ASIC), a field-programmable gate array (FPGA), or another type of programmable device, which is configured to execute algorithms to perform control functions as described herein.

In some embodiments, the energy metering/monitoring circuitry 152 is configured to measure power and energy usage of loads that are protected by the GFCI device 100. For example, in some embodiments, the energy metering/monitoring circuitry 152 is configured to process instantaneous voltage and current waveforms to compute RMS values of voltage and currents, active, reactive and apparent power and energies. In some embodiments, the energy metering/monitoring circuitry 152 comprises a microprocessor, an ASIC, or an application-specific standard product (ASSP) chip that implements the desired energy metering functionalities.

The wireless communications circuitry 153 is configured to enable communication between the GFCI device 100 and one or more remote computing devices and systems (e.g., computer or smart electrical device). In some embodiments, the wireless communications circuitry 153 comprises transmitter circuitry. In other embodiments, the wireless communications circuitry 153 comprises transmitter and receiver circuitry (e.g., transceiver circuitry). The wireless communications circuitry 153 can implement proprietary or standard wireless communication protocols. For example, the wireless communications circuitry 153 can implement a standard wireless communication protocol such as Wi-Fi®, near-field communication (NFC), Bluetooth®, Bluetooth Low Energy (BLE), or ZigBee®, and other types of standards-based wireless mesh networks. In some embodiments, the wireless communication and networking functions of the GFCI device 100 are configured to enable ad-hoc network communication between network adjacent smart electrical devices, and communicating with other network nodes which operate as edge computing nodes to collect and process data to implement one or more applications.

In some embodiments, the antenna 153-1 comprises one or more printed/planar antenna elements (radiators) and transmission lines which are configured to receive wireless radio signals that are input to and processed by the wireless communications circuitry 153, and to transmit wireless radio signals generated by wireless communications circuitry 153 to wirelessly transmit information (e.g., operating status of the GFCI device 100, reporting fault conditions, etc.) to a remote node. The antenna 153-1 is configured to capture and transmit wireless signals at the operating frequency or frequencies of the wireless communications circuitry 153 (e.g., 2.4 GHz or 5 GHz Industrial, Scientific and Medical (ISM) bands, etc.)

Furthermore, in some embodiments, the memory devices 154 comprise volatile memory (e.g., RAM) and non-volatile memory such as a flash memory device, a solid-state drive (SSD) device, or other types and combinations of non-volatile memory devices, which are suitable for the given application. The memory devices 154 are utilized for various purposes including, but not limited to, (i) storing program code and configuration data, etc., which is utilized by the various system components 151, 152, and 153 to perform respective functions (e.g., control and manage the sensing, data processing, and communication operations, etc.), (ii) persistently storing an operating state of the GFCI device 100, (iii) storing digital data generated by the first and second ADC circuits 130 and 132, (iv) storing data processing results generated by the digital controller 151, (v) storing power usage information generated by the energy metering/monitoring circuitry 152, and (vi) otherwise providing local persistent storage for other purposes, as needed.

The status LEDs 155 include one or more LED devices that are configured to illuminate in response to control signals received from the digital circuitry 150 to indicate an operating status of the GFCI device 100. The status LEDs 155 can generate and emit, or otherwise have different colors (e.g., red, green, yellow, blue, etc.) and/or have different illumination patterns (e.g., continuous, blinking, etc.) which represent different operational states of the GFCI device 100. For example, in some embodiments, the status LEDs 155 can have an LED that emits a certain color (e.g., continuous green color) which indicates that the GFCI device 100 has power and is correctly operating in a normal state. Moreover, in some embodiments, the status LEDs 155 can have an LED that emits a certain color (e.g., red) to visually display an alarm condition, e.g., that the GFCI device 100 has tripped as a result of a ground fault, overloading, short circuit, and the like, or the GFCI device 100 has carried out a self-test and failed. Further, in some embodiments, the status LEDs 155 can have an LED that emits a certain color (e.g., blue) that indicates a status of network connection, wherein a solid blue LED indicates that the GFCI device 100 is connected to a given network, and a blinking blue LED indicates that the GFCI device 100 is not connected to the network or is in the process of connecting to the network.

In some embodiments, the power converter circuit 120 is configured to convert AC power, which is supplied on the hot and neutral lines 101 and 102, into DC power. In particular, in some embodiments, the power converter circuit 120 generates one or more DC operating voltages, as needed, to provide DC supply power the various components (e.g., first and second ADC circuits 130 and 132, the calibration circuitry 140, the digital circuitry 150, etc.) of the GFCI device 100. The power converter circuit 120 can be implemented using suitable AC-to-DC conversion techniques.

The first shunt resistor 110 comprises a current sensor resistor that is configured to sense a magnitude of a line current (denoted I_{L}) which flows in a hot electrical path between the hot line 101 (first power input terminal 100A) and the output node N3. Similarly, the second shunt resistor 112 comprises a current sensor resistor that is configured to sense a magnitude of a neutral current (denoted I_{N}) which flows in a neutral electrical path between the neutral line 102 (second power input terminal 100B) and the output node N4. In operation, the first shunt resistor 110 generates a first analog sense voltage which is proportional to the magnitude of the line current I_{L}, and the second shunt resistor 112 generates a second analog sense voltage which is proportional to the neutral current I_{N}. In some embodiments, the first and second shunt resistors 110 and 112 are each implemented using a Kelvin current sensor device. The Kelvin current sensor device comprises a four-terminal current sensor device comprising a shunt resistor and an integrated Kelvin connection, wherein two terminals are utilized to enable current flow through the shunt resistor, and two terminals are utilized for outputting an analog sense voltage which corresponds to a magnitude of the current flow through the shunt resistor.

For example, as shown in FIG. 1, the first shunt resistor 110 comprises (i) first and second terminals T1 and T2 (current-carrying electrodes) which allow line current I_{L} to flow through the first shunt resistor 110 in the electrical path between the hot line 101 (first power input terminal 100A) and the output node N3, and (ii) third and fourth terminals T3 and T4 (voltage-sensing electrodes) which generate an analog sense voltage based on a magnitude of the line current I_{L} that flows through the first shunt resistor 110. Similarly, the second shunt resistor 112 comprises (i) first and second terminals T1 and T2 which allow neutral current I_{N} to flow through the second shunt resistor 112 in the electrical path between the neutral line 102 (second power input terminal 100B) and the second output node N4, and (ii) third and fourth terminals T3 and T4 which generate an analog sense voltage based on a magnitude of the neutral current I_{N} which flows through the second shunt resistor 112. The 4-terminal Kelvin shunt resistor devices are configured to maximize measurement accuracy by separating the path of high current flow through the current sense resistor from the voltage sensing path.

As further shown in FIG. 1, the voltage-sensing terminals T3 and T4 of the first shunt resistor 110 are coupled to the input of the first ADC circuit 130, and the voltage-sensing terminals T3 and T4 of the second shunt resistor 112 are coupled to the input of the second ADC circuit 132. In this configuration, the analog sense voltage which is output from the first shunt resistor 110 is digitized by the first ADC circuit 130, and the analog sense voltage which is output from the second shunt resistor 112 is digitized by the second ADC circuit 132. The digitized sense voltage generated by the first ADC circuit 130 represents the magnitude of the line current I_{L}, and the digitized sense voltage generated by the second ADC circuit 132 represents the magnitude of the neural current I_{N}.

In some embodiments, the first and second ADC circuits 130 and 132 comprise high-resolution sigma-delta (ΣΔ) analog-to-digital converters which are configured to generate high-resolution digital waveforms representing the monitored line current I_{L} and neutral current I_{N}. The line and neutral currents I_{L} and I_{N} are continuously monitored to generate corresponding digitized voltage sense waveforms, wherein the discrete values of the digitized voltage sense waveforms are continuously read and processed by the control circuitry (e.g., the digital controller 151 and/or the energy metering/monitoring circuitry 152) to detect potential faults. For example, any detected differences between the line and neutral current I_{L} and I_{N}, e.g., as small as 4-6 mA (e.g., for a 20 A power load) are algorithmically synthesized to determine a ground fault condition.

When a ground fault is detected, the digital circuitry 150 (e.g., the digital controller 151) generates and outputs a control signal to the contact trip control element 160 which, in turn, causes the latching contacts 162 to open and disconnect the AC power from the output nodes N3 and N4, which interrupts power to (i) the load 105 connected to the receptacle 170 and/or (ii) downstream devices coupled to the first and second load terminals 100C and 100D. More specifically, in an exemplary embodiment such as shown in FIG. 1 where the GFCI device 100 comprises a GFCI outlet, the load 105 would be plugged into one of the receptacles 170 of the GFCI device 100. As noted above, additional downstream electrical devices (e.g., outlet devices) can be connected to the GFCI device 100 by connecting such downstream devices to the first and second load terminals 100C and 100D of the GFCI device 100. As schematically illustrated in FIG. 1, the first and second load terminals 100C and 100D are coupled to the respective first and second nodes N3 and N4 such that when the latching contacts 162 are opened (e.g., as a result of a detected ground fault), the first and second load terminals 100C and 100D are effectively disconnected from the hot line 101 and the neutral line 102, thereby interrupting AC power to the downstream devices.

In some embodiments, the calibration circuitry 140 is configured and utilized to perform calibration and self-test operations to ensure that the GFCI device 100 is functioning correctly. For example, in some embodiments, the calibration circuitry 140 comprises a power load resistor and a switching circuit which is configured to selectively connect the power load resistor between the line and neutral nodes N1 and N2 to calibrate and check the health of the GFCI device 100.

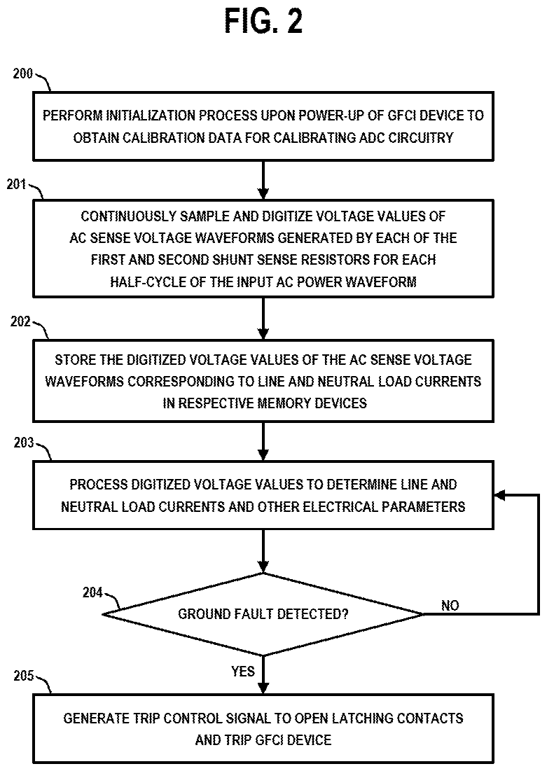

FIG. 2 illustrates a flow diagram of a method for detecting and protecting against ground fault conditions, according to an exemplary embodiment of the disclosure. In particular, FIG. 2 illustrates exemplary modes of operation of the GFCI device 100 of FIG. 1. Upon power up of the GFCI device 100, an initialization process is performed to obtain calibration data to calibrate the current sensing circuitry and functionality of the GFCI device 100 (block 200). For example, in some embodiments, an initialization/calibration process is performed as follows. The digital controller 151 generates and outputs a calibration control signal to the calibration circuitry 140, which causes the calibration circuitry 140 to switchably connect a power load resistor between the line and neutral nodes N1 and N2. The power load resistor comprises a relatively high resistance value which cases a relatively small amount of AC current (e.g., substantially zero current) to flow through the first and second shunt resistors 110 and 112. As a result, the first and second shunt resistors 110 and 112 output small AC voltages (e.g., zero-current voltages) which correspond to substantially zero current flow through the first and second shunt resistors 110 and 112. The first and second ADC circuits 130 and 132 digitize the “zero-current voltages” output from the respective first and second shunt resistors 110 and 112, and the digital circuitry 150 processes the digitized zero-current voltage to determine any differences between the first and second ADC circuits 130 and 132 and/or the first and second shunt resistors 110 and 112, and determine correction parameters that are utilized to offset such differences during normal operation of the real time operation, to thereby ensure accurate sensing functionality.

Upon completion of the initialization process, the digital controller 151 generates and outputs a calibration control signal to the calibration circuitry 140, which causes the calibration circuitry 140 to switchably disconnect the power load resistor from the line and neutral nodes N1 and N2, and the GFCI device 100 enters into a wait state until a flow of load current is detected. When load current flows to the load 105 and/or some downstream load coupled to the first and second load terminals 100C and 100D of the GFCI device 100, the resulting flow of line load current I_{L} and neutral load current I_{N} through the first and second shunt resistors 110 and 112 causes AC sense voltages to be generated across the third and fourth terminals T3 and T4 of the respective first and second shunt resistors 110 and 112, and the sense voltages are applied to the inputs of the first and second ADC circuits 130 and 132. The AC sense voltages correspond to the line load current I_{L} and the neutral load current I_{N} through the first and second shunt resistors 110 and 112 by the relation V=IR, where I denotes the line load current I_{L} or neutral load current I_{N}, and where R denotes a resistance value of the first shunt resistor 110 or the second shunt resistor 112 (where the shunt resistance is selected to be significantly small to minimize power consumption). The first and second ADC circuits 130 and 132 are triggered in response to 0V crossings of the AC sense voltage waveforms generated and output from the first and second shunt resistors 110 and 112, respectively. Once triggered, the first and second ADC circuits 130 and 132 will continuously sample and digitize voltage values of the AC sense voltage waveforms that are generated and output from the respective first and second shunt resistors 110 and 112 for each half-cycle of the AC power waveform (block 201). In some embodiments, as noted above, the digitized voltage values that are generated and output from the first and second ADC circuits 130 and 132 are stored in respective memory devices (block 202). In other embodiments, the digitized voltage values that are generated and output from the first and second ADC circuits 130 and 132 are stored in a same memory device, but in different allocated portions of the memory device, which are allocated to the respective first and second ADC circuits 130 and 132.

The digital circuitry 150 (e.g., digital controller 151 and/or energy metering/monitoring circuitry 152) accesses the stored digital voltage values from the memory devices and processes the digitized voltage values to determine the magnitudes of the line and neutral load currents and other electrical parameters (block 203), wherein the processing result are utilized to determine if a ground fault condition is present (block 204). When a ground fault condition is detected (affirmative result in block 204), the digital controller 151 will generate and output a trip control signal to the contact trip control element 160, which then generates a signal to the trip the latching contacts 162 and disconnect the AC power from the load output nodes N3 and N4 and thus disconnect the AC power from the load 105 and/or downstream loads coupled to the first and second load terminals 100C and 100D.

In some embodiments, the memory devices 154 include a plurality of dual-port RAM devices which are utilized to store the digitized voltage values output from the first and second ADC circuits 130 and 132, and to store processing results (e.g., Peak and RMS values) that are generated by the digital circuitry 150 for each cycle of the AC power. For example, in some embodiments, the memory devices 154 comprise two (2) separate dual-ported RAM devices for storing and accessing data associated with the monitored line load current I_{L}, and two (2) separate dual-ported RAM devices for storing and accessing data associated with the monitored neutral load current I_{N}.

In particular, a first dual-ported RAM device is utilized to enable the first ADC circuit 130 to continuously store digital voltage values corresponding to the monitored line load current I_{L} while the allowing the digital processing circuitry (e.g., digital controller 151 and/or energy metering/monitoring circuitry 152) to concurrently access the stored digital voltage values for processing. In addition, a second dual-ported RAM device is utilized to enable the second ADC circuit 132 to continuously store digital voltage values corresponding to the monitored neutral load current I_{L} while the allowing the digital processing circuitry (e.g., digital controller 151 and/or energy metering/monitoring circuitry 152) to concurrently access the stored digital voltage values for processing.

Moreover, a third dual-ported RAM device is utilized to enable the digital processing circuitry (e.g., digital controller 151 and/or energy metering/monitoring circuitry 152) to store processing results associated with the monitored line load current I_{L}, and a fourth dual-ported RAM device is utilized to enable the digital processing circuitry (e.g., digital controller 151 and/or energy metering/monitoring circuitry 152) to store processing results associated with the monitored neutral load current I_{N}.

In some embodiments, the dual-ported RAM devices have enough storage to maintain information for multiple cycles of the AC power to determine if a fault condition exists. For example, in some embodiments, the dual-port RAM devices comprise a storage capacity of, e.g., 1.5 kilobits (24-bits×64 addresses) to store the digitized results of the first and second ADC circuits 130 and 132. During operation, the first and second dual-ported RAM devices associated with the monitored line load current I_{L}, will be utilized to store the digitized voltage values from the first ADC circuit 130 for a current AC power cycle in the first dual-ported RAM device, while the processing results (reporting) are stored in the second dual-ported RAM device based on the stored digitized voltage values from a previous cycle. Similarly, the third and fourth dual-ported RAM devices associated with the monitored neutral load current I_{N} will be utilized to store the digitized voltage values from the second ADC circuit 132 for a current AC power cycle in the third dual-ported RAM device, while the processing results (reporting) are stored in the fourth dual-ported RAM device based on the stored digitized voltage values from a previous cycle.

In some embodiments, for each cycle of the AC power, various types of data and processing results will be generated, stored, and reported (in block 203, FIG. 2) in connection with the monitored line and neutral load currents I_{L} and I_{N}. For example, in some embodiments, for each cycle of AC power, the following data is individually measured and reported for both the hot line (Line) and the neural line (Neutral):

(i) Instantaneous Voltage: the instantaneous voltage values of the AC sense voltage waveforms (generated by the first and second shunt resistors 110 and 112) are measured, digitized, and stored for processing and analysis;

(ii) Peak Voltage: a peak voltage on the hot line and the neutral line is determined for each AC power cycle by computing an average of a maximum voltage that is measured in each half-cycle of a given AC power cycle;

(iii) Peak Current: a peak current value (e.g., peak I_{L} and peak I_{N}) is determined for each AC power cycle by computing an average of a maximum voltage that is measured in each half-cycle of a given AC power cycle, and dividing the average maximum voltage by the resistance value of the shunt resistor (I=V/R), e.g., the peak current value for a given AC power cycle is determined by dividing peak the determined voltage for the given AC power cycle by the resistance value of the shunt resistor;

(iv) RMS Voltage: a root mean square (RMS) voltage value is determined for each full cycle of AC power based on the measured instantaneous voltage values that are measured and stored for the full cycle of AC power, e.g.,

$$R M S = \sqrt[2]{\frac{{( V 1 )}^{2} + {( V 2 )}^{2} + {( V 3 )}^{2} + … , {( V 64 )}^{2}}{64}} ,$$

assuming 64 instantaneous voltage values (V1, V2, V3, . . . , V64) are measured for the each full cycle of AC power, and the RMS current value for the full cycle can be determined based on the computed RMS voltage value and the resistance value of the shunt resistor;

(v) Ground Fault: a ground fault detection is reported when a ground fault condition is deemed to occur. In some embodiments, a ground fault condition is deemed to occur when a difference (Δ) between the computed peak current and RMS current values for the Line and Neutral is more than, e.g., 4 mA over a span of a specified number n of full cycles of the AC power (e.g., n=8 cycles), wherein a fault is determined as: Fault =4 mA×R, where R is the resistance value of the current sensing shunt resistor.

In this regard, the digital circuitry 150 of the GFCI device 100 will continuously monitor the digitized current delta between the Line and Neutral wires over a power load, and determine that a ground fault condition exists when the digitized peak current values and/or RMS current values are determined to differ by an amount that meets or exceed a difference threshold A_{Threshod} over the specified number n of full cycles of the AC power. In some embodiments, A_{Threshod} is in a range of about 4 mA to about 6 mA.

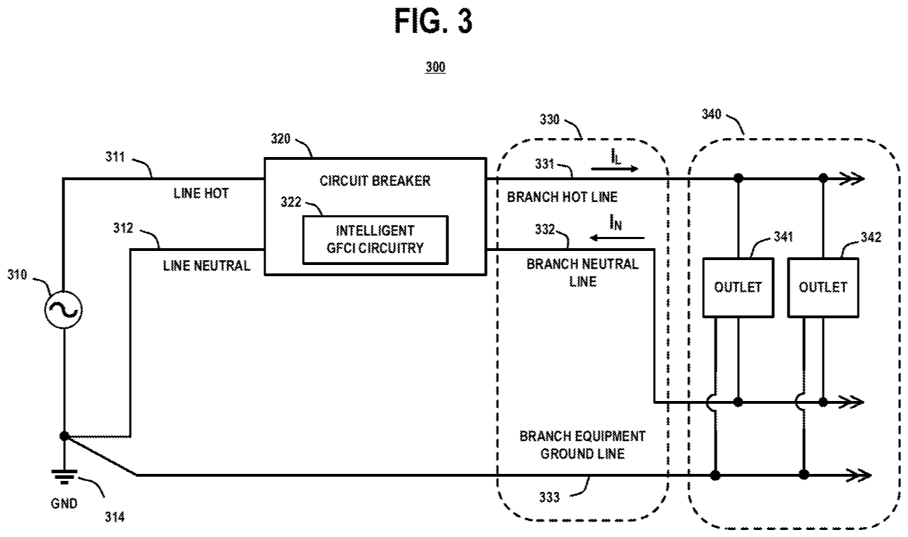

FIG. 3 schematically illustrates system 300 for detecting and protecting against ground fault conditions, according to an exemplary embodiment of the disclosure. The system 300 comprises an AC power source 310 (e.g., AC mains), a circuit breaker 320, a branch circuit feed 330, and a branch circuit 340. The circuit breaker 320 comprises intelligent GFCI circuitry 322 which, in some embodiments, is implemented using a GFCI circuit architecture similar to the GFCI architecture shown in FIG. 1, but further adapted for use in conjunction with circuit breaker functionality. The AC power source 310 is coupled to the circuit breaker 320 by a hot line 311 and neutral line 312. In an exemplary embodiment where the circuit breaker 320 is connected in a power distribution panel, the hot line 311 comprises a hot phase bus bar of the power distribution panel, and the neutral line 312 comprises a neutral “pig tail” connection to a neutral bus bar of the power distribution panel. In addition, as schematically shown in FIG. 3, the neutral line 312 is coupled to earth ground 314. In an exemplary embodiment where the circuit breaker 320 is connected in a power distribution panel, the earth ground would be connected to a ground bus bar in the power distribution panel, and the neutral bus bar would be bonded to the ground bar assuming that the power distribution panel is a primary panel directly coupled to the AC power source 310, and not a sub-panel (in which case the ground bus bar and neutral bus bar would be isolated in the sub-panel).

The branch circuit feed 330 connects the circuit breaker 320 to a branch circuit 340 comprising a plurality of electrical devices (e.g., outlets 341 and 342). The branch circuit feed 330 comprises a branch hot line 331, a branch neutral line 332, and a branch equipment ground line 333. In the exemplary embodiment of FIG. 3, the circuit breaker 320 is configured to protect the branch circuit 340 from various fault conditions including, but not limited to, short-circuit fault conditions, over-current fault conditions, arc-fault conditions, etc., as well as ground fault conditions via the intelligent GFCI circuitry 322. For example, using techniques as discussed above in conjunction with FIG. 1, the intelligent GFCI circuitry 322 can monitor and measure the line load current I_{L} and neutral load current I_{N} (flowing in the branch circuit feed lines (branch hot line 331 and branch neutral line 332)) using high precision current sense resistors and ADC circuits, and process digitized voltage signals corresponding to the line and neutral load currents I_{L} and I_{N} via digital control circuit to detect a potential ground fault. In other embodiments, the digitized voltage values can be processed to detect other fault conditions (e.g., arc-fault conditions, over-current conditions, etc.) as desired.

In some embodiments, the circuit breaker 320 comprises an intelligent solid-state circuit breaker which is implemented using exemplary circuit breaker architectures and techniques as disclosed in U.S. Pat. No. 11,373,831, which is commonly assigned and fully incorporated herein by reference. In some embodiments, the circuit breaker 320 can be configured to interrupt current flow to the branch circuit by generating a control signal in response to detection of a ground fault condition to turn off (deactivate) one or more solid-state switches (e.g., bidirectional solid-state switches) in addition to activating an electromechanical mechanism to trip a mechanical air-gap switch of the circuit breaker 320.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A device, comprising:
current sense circuitry configured to sense a first current flowing in a first wire and to sense a second current flowing in a second wire, the first and second wires being configured to supply alternative current (AC) power to a load coupled to the device;
analog-to-digital converter circuitry configured to generate first digital data corresponding to the first current, and to generate second digital data corresponding to the second current; and
digital signal processing circuitry configured to (i) process the first digital data and the second digital data to determine a difference between the first current and the second current, and (ii) generate a control signal to interrupt current flow in the first and second wires, in response to determining that the difference between the first current and the second current meets or exceeds a difference threshold.

2. The device of claim 1, wherein the digital signal processing circuitry is configured to:
process the first digital data to determine a first peak current in each cycle of the AC power;
process the second digital data to determine a second peak current in each cycle of the AC power;
determine a difference between the first current and the second current as a difference between the first peak current and the second peak current in each cycle of the AC power; and
generate the control signal to interrupt the current flow in the first and second wires, at least in response to determining that the difference between the first peak current and the second peak current meets or exceeds the difference threshold over a specified number of consecutive cycles of the AC power.

3. The device of claim 1, wherein the digital signal processing circuitry is configured to:
process the first digital data to determine a first root mean square (RMS) current in each cycle of the AC power;
process the second digital data to determine a second RMS current in each cycle of the AC power;
determine a difference between the first current and the second current as a difference between the first RMS current and the second RMS current in each cycle of the AC power; and
generate the control signal to interrupt the current flow in the first and second wires, at least in response to determining that the difference between the first RMS current and the second RMS current meets or exceeds the difference threshold over a specified number of consecutive cycles of the AC power.

4. The device of claim 1, wherein the current sense circuitry comprises:
a first current sense resistor configured to generate a first sense voltage which corresponds to the first current flowing in the first wire; and
a second current sense resistor configured to generate a second sense voltage which corresponds to the first current flowing in the second wire.

5. The device of claim 4, wherein the first current sense resistor and the second current sense resistor each comprises a four-terminal Kelvin resistor.

6. The device of claim 4, wherein the analog-to-digital converter circuitry comprises:
a first analog-to-digital converter circuit configured to digitize the first sense voltage to generate the first digital data; and
a second analog-to-digital converter circuit configured to digitize the second sense voltage to generate the second digital data.

7. The device of claim 1, wherein the device comprises a ground fault circuit interrupter outlet device.

8. The device of claim 1, wherein the device comprises a ground fault circuit interrupter circuit breaker device.

9. A device, comprising:
a first electrical path and a second electrical path configured to supply alternative current (AC) power to a load coupled to the device;
a first current sense resistor configured to generate a first sense voltage corresponding to a first current flowing in the first electrical path;
a second current sense resistor configured to generate a second sense voltage corresponding to a second current flowing in the second electrical path;
a first analog-to-digital converter circuit configured to convert the first sense voltage to a first digital voltage;
a second analog-to-digital converter circuit configured to convert the second sense voltage to a second digital voltage; and
control circuitry configured to (i) process the first digital voltage and the second digital voltage to determine a difference between the first current and the second current, and (ii) generate a control signal to interrupt current flow in the first and second electrical paths, in response to determining that the difference between the first current and the second current meets or exceeds a difference threshold.

10. The device of claim 9, wherein the first current sense resistor and the second current sense resistor each comprise a four-terminal Kelvin resistor device.

11. The device of claim 9, wherein the control circuitry is configured to:
process the first digital voltage to determine a first peak voltage in each cycle of the AC power, and determine a first peak current which corresponds to the first peak voltage based on a resistance of the first current sense resistor;
process the second digital voltage to determine a second peak voltage in each cycle of the AC power, and determine a second peak current which corresponds to the second peak voltage based on a resistance of the second current sense resistor;
determine a difference between the first current and the second current as a difference between the first peak current and the second peak current in each cycle of the AC power; and
generate the control signal to interrupt the current flow in the first and second electrical paths through the device, at least in response to determining that the difference between the first peak current and the second peak current meets or exceeds the difference threshold over a specified number of consecutive cycles of the AC power.

12. The device of claim 9, wherein the control circuitry is configured to:
process the first digital voltage to determine a first root mean square (RMS) voltage in each cycle of the AC power, and determine a first RMS current which corresponds to the first RMS voltage based on a resistance of the first current sense resistor;
process the second digital voltage to determine a second RMS voltage in each cycle of the AC power, and determine a second RMS current which corresponds to the second RMS voltage based on a resistance of the second current sense resistor;
determine a difference between the first current and the second current as a difference between the first RMS current and the second RMS current in each cycle of the AC power; and
generate the control signal to interrupt the current flow in the first and second electrical paths through the device, at least in response to determining that the difference between the first RMS current and the second RMS current meets or exceeds the difference threshold over a specified number of consecutive cycles of the AC power.

13. The device of claim 9, further comprising:
a first dual-ported memory device configured enable the first analog-to-digital converter circuit to store digital values of the first digital voltage in a current cycle of the AC power, while the control circuitry reads digital values of the first digital voltage stored in a previous cycle of the AC power; and
a second dual-ported memory device configured enable the second analog-to-digital converter circuit to store digital values of the second digital voltage in the current cycle of the AC power, while the control circuitry reads digital values of the second digital voltage stored in the previous cycle of the AC power.

14. The device of claim 9, wherein the first analog-to-digital converter circuit and the second analog-to-digital converter circuit each comprise a delta-sigma analog-to-digital converter.

15. The device of claim 9, wherein the device comprises a ground fault circuit interrupter outlet device.

16. The device of claim 9, wherein the device comprises a ground fault circuit interrupter circuit breaker device.

17. The device of claim 9, wherein the device comprises at least one of an electromechanical switch and a solid-state switch that is responsive to the control signal to interrupt the current flow in the first and second electrical paths through the device.

18. A method, comprising:
sensing a first current flowing in a first wire and a second current flowing in a second wire, the first and second wires being configured to supply alternative current (AC) power to a load;
generating first digital data corresponding to the first current, and second digital data corresponding to the second current; and
processing the first digital data and the second digital data to determine a difference between the first current and the second current, and generate a control signal to interrupt current flow in the first and second wires, in response to determining that the difference between the first current and the second current meets or exceeds a difference threshold.

19. The method of claim 18, wherein processing the first digital data and the second digital data comprises:
processing the first digital data to determine a first peak current in each cycle of the AC power;
processing the second digital data to determine a second peak current in each cycle of the AC power;
determining a difference between the first current and the second current as a difference between the first peak current and the second peak current in each cycle of the AC power; and
generating the control signal to interrupt the current flow in the first and second wires, at least in response to determining that the difference between the first peak current and the second peak current meets or exceeds the difference threshold over a specified number of consecutive cycles of the AC power.

20. The method of claim 18, wherein processing the first digital data and the second digital data comprises:
processing the first digital data to determine a first root mean square (RMS) current in each cycle of the AC power;
processing the second digital data to determine a second RMS current in each cycle of the AC power;
determining a difference between the first current and the second current as a difference between the first RMS current and the second RMS current in each cycle of the AC power; and
generating the control signal to interrupt the current flow in the first and second wires, at least in response to determining that the difference between the first RMS current and the second RMS current meets or exceeds the difference threshold over a specified number of consecutive cycles of the AC power.
